(19) United States
(12) Patent Application Publication
(10) Pub. No.: US 2006/0148430 A1
(43) Pub. Date: Jul. 6, 2006

(54) Power management of a transmitter and supporting methods and apparatus

(75) Inventors: Gustavo D. Leizerovich, Aventura, FL (US); John J. Bozeki, Elgin, IL (US); Clarence K. Coffee, Pembroke Pine, FL (US); Josh E. Dorevitch, Chicago, IL (US); Paul H. Gailus, Prospect Heights, IL (US); Mark A. Kirschenmann, Chandler, AZ (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc.

(21) Appl. No.: 11/026,945

(22) Filed: Dec. 30, 2004

(51) Int. Cl. H04B 1/04; H04B 7/00

(52) U.S. Cl. 455/127.1; 455/522

(57) ABSTRACT

In the present technique for managing power of a transmitter on a mobile station, the transmitter power is checked (124) against a training current threshold that can result in the termination of a training ramp during level training mode of the mobile station. Another transmission current threshold is used for comparison (134) with the transmitter current that effectually reduces the power of the transmitter as needed.

### TECHNICAL FIELD

This invention relates generally to power management of a transmitter on a mobile station.

### BACKGROUND

Some mobile stations, such as iDEN® radios, are configured without an isolator from the transmitter lineup. Without the isolator at the transmitter lineup of the mobile station, the radio is now susceptible to drawing excessive current under high voltage standing wave ratio (“VSWR”) conditions, which may cause an early radio shutdown. Please note that for clarity, a mobile station will be used herein to refer to any device that requires power management of a transmitter in the device itself. As such, mobile stations include, but are not limited to, a cell phone, personal digital assistant, and/or a laptop computer.

Depending upon the antenna load impedance, the worst case of drawing excessive current under VSWR occurs during transmit level training as described in U.S. Pat. No. 5,066,923 entitled “Linear Transmitter Training Method and Apparatus” and issued to Gailus et al., which is incorporated by reference in its entirely. The radio frequency power amplifier (“RFPA”), during transmit level training, is taken into deep compression with its associated high current in order to assess a non-linear point of the RFPA. Specifically, during level training, the RFPA is driven into hard compression to assess the baseband digital in-phase and quadrature (“I/Q”) levels that correspond to a certain level of compression, typically 2 dB. This is done by driving a linear ramp into the Cartesian feedback loop and monitoring the loop error signal. When the error signal exceeds a certain threshold, the “clip” point is detected and the baseband level that caused the “clip” is determined. From this information obtained, the modulation data peaks are prevented from exceeding the “clip” point.

Although the training level provides useful information, operating conditions are inevitably encountered where the high current peaks of the training level draw such excessive current that an early radio shutdown results. The high current peaks that cause the premature radio shutdown generally happen when running the level training operation while the RFPA is experiencing a high VSWR that yields high current. Another scenario of high current peaks that cause an early radio shutdown is the transmission of data peaks while the RFPA experiences a high VSWR that yields high current. The problem of an early shutdown is exacerbated when an additional current load (e.g., speakerphone, application processor, advance displays, display backlight, and adjunct processor) is present at the same time as the two scenarios of transit level training and transmit data peaks. A prior method of timing out the level training ramp has attempted to deal with these issues. This prior method, however, does not always work since level training takes place in an open loop mode, and a timer shutdown is simply too rigid to accommodate the range of operating conditions encountered while in open loop mode. As a result, in many cases, the prior method causes unnecessary termination of the training ramp.

### BRIEF DESCRIPTION OF THE DRAWINGS

The above needs are at least partially met through provision of a power management of the transmitter in a mobile station described in the following detailed description, particularly when studied in conjunction with the drawings, wherein:

FIG. 1 comprises a block diagram depiction of a linear transmitter constructed in accordance with various embodiments of the invention;

FIG. 2 comprises a flow chart diagram of a process according to various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, it is determined whether a started transmitter slot is in a level training mode. If so, a transmitter current is compared to a training current threshold that can terminate the level training to avoid excessive power usage. Otherwise, the transmitter current is compared to a transmission current threshold that can reduce the power of the transmitter to balance the power usage load of the transmitter.

Specifically, in various embodiments described, when the started transmitter slot is in level training, a training ramp is initiated followed by a determination of whether the transmitter current corresponds in at least a predetermined way to the training current threshold. The training ramp that was initiated will be terminated if the transmitter current corresponds in at least the predetermined way to the training current threshold. In various embodiments shown, the training current threshold can be a predefined value or a dynamically assigned value, which includes, but is not limited to, a radio frequency amplifier current, a mobile station current, and a total mobile station current. In one embodiment, it is determined whether a sum voltage corresponds in at least a predetermined way to a clip threshold. If so, the training ramp that was initiated will be similarly terminated. In various teachings described, some initial variables are initialized before the training ramp is activated, specifically a power of the transmitter is reset to a nominal level. A slot counter value and/or a transmitter time value of the transmitter is also reset to its initial values in one embodiment.

When the started transmitter slot is not in level training, in various embodiments, a data transmission is initiated and the transmitter current is instead compared to determine whether it corresponds in at least a predetermined way to the transmission current threshold. If so, the power of the transmitter is set to a reduced level. This process is repeated for each transmitter slot until substantially all the transmitter slots have been processed. After the transmitter slot has come to an end, the slot counter value will be incremented, and it is determined whether the incremented slot counter value or the transmitter timer value respectively corresponds to a predefined counter limit or timer limit. If so, the incremented slot counter value or the transmitter timer value will be reset to an initial value. In one embodiment, the power of the transmitter is also set to a nominal level in response to the end of the transmitter slot.

Through these various teachings, the radio's susceptibility to drawing excessive current under VSWR conditions is minimized. As a result, an unnecessary early radio shutdown has been substantially eliminated. The various teachings can properly terminate the level training mode and/or reduce power for a data transmission that may cause high current peaks, which would result in premature radio shutdown of the transmitter. The various embodiments are also able to work with the existing clip detector, which is commonly known in the art, that also controls the power current of the transmitter through the clip threshold. As such, the transmitter current is properly monitored and controlled. As a result of the various embodiments described, an early radio shutdown of the transmitter is avoided by controlling the high current peaks of the transmitter.

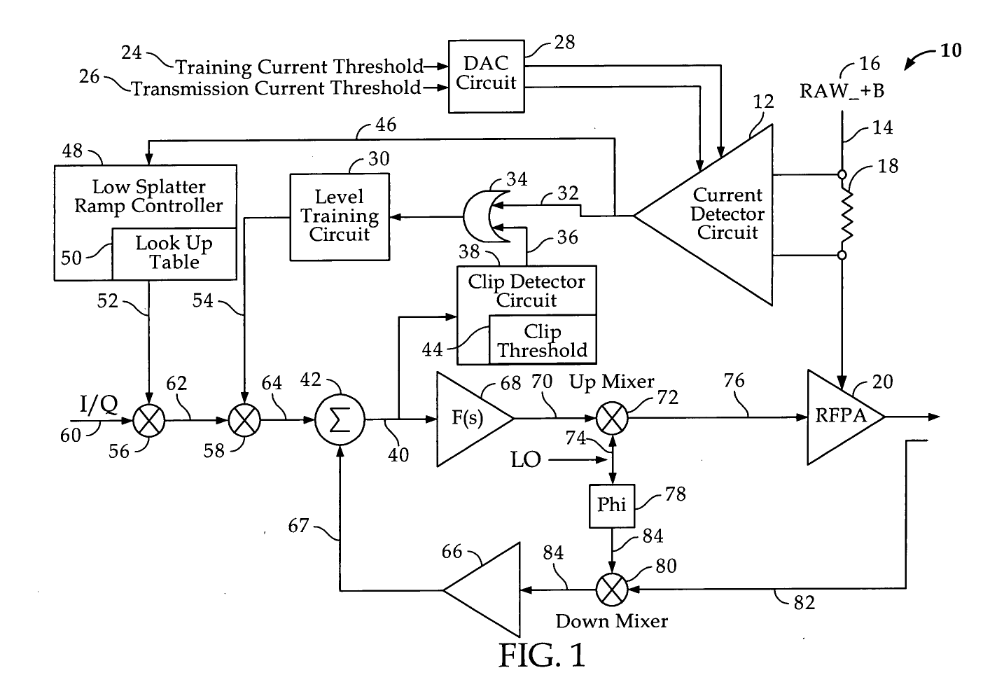

Referring now to the drawings, and in particular to FIG. 1, for purposes of providing an illustrative but nonexhaustive example to facilitate this description, a Cartesian feedback transmitter in accordance with various embodiments is shown and indicated generally at 10. Those skilled in the art, however, will recognize and appreciate that the specifics of this illustrative example are not specifics of the invention itself and that the teachings set forth herein are applicable in a variety of alternative embodiments.

In this embodiment, a current detector circuit 12 receives a transmitter current 14, which is a power current from a power source 16 that has been converted into a voltage by a sensing resistor 18. In addition, the transmitter current 14 is also forwarded to a RFPA 20. The current detector circuit 12 also receives a training current threshold 24 and a transmission current threshold 26. These two thresholds 24, 26 may be predefined and/or dynamically assigned. If these thresholds 24, 26 are dynamically assigned, a digital-to-analog converter circuit 28 is used to convert the digital signal to analog values for use with the current detector circuit 12. Depending upon the specific implementations, the training current threshold 24 and the transmission current threshold 26 can have the same or different values from each other.

The transmitter 10 begins by starting a transmitter slot, and responsive to the start of the transmitter slot, it determines whether the transmitter slot is currently in a level training mode. If so, a training ramp is initiated via a level training circuit 30. While the training ramp is activated, the transmitter current 14 from the RFPA 20 is checked with a comparison to the training current threshold 24 to determine whether the training ramp should be terminated. From this, high peak current from the RFPA 20 caused by the training ramp is avoided, because the transmitter current 14 from the RFPA is checked throughout execution of the training ramp. As a result, the training ramp cannot draw excessive current that would cause an early shutdown of the transmitter 10 because it will be terminated before such an early shutdown can occur.

This determination 32 to terminate or maintain the training ramp from the current detector 12 is forwarded to an OR gate 34 that also receives an output 36 from a clip detector circuit 38. The clip detector circuit 38, which is commonly known in the art, also compares a sum voltage 40 from a summation circuit 42 to a clip threshold 44 to determine whether the training ramp should be terminated. The OR gate 34, using inputs 32, 36 from both the current detector circuit 12 and clip detector circuit 38, instructs the level training circuit 30 to either maintain or terminate the training ramp. Note that the training ramp can be terminated under two scenarios in this embodiment. Specifically, a sum voltage 40 that exceeds the clip threshold 44 and/or a transmitter current 18 from the RFPA 20 that exceeds the training current threshold 24 can both result in the termination of the training ramp.

Aside from the control of the level training circuit 30, the current detector circuit 12 also controls power usage during data transmission. This is the case when the selected transmitter slot is not in level training, which means, in this particular embodiment, that the transmitter slot will be used for data transmission. As a result, a data transmission is initiated for the selected transmitter slot. In this embodiment, the transmitter current 14 from the RFPA 20 is compared to the transmission current threshold 26. If the transmitter current 14 fails the comparison with the transmission current threshold 26, the current detector circuit 12 sends an output 46 to reduce the power of the transmitter. A low splatter ramp controller circuit 48, responsive to the output 46, sets the power of the transmitter to a reduced level using a look up table 50. As commonly known in the art, the power of the transmitter consists of three states, specifically a nominal level, a reduced level, and an off level. In this case, to avoid the data transmission of the transmitter slot from causing high current peaks that may cause an early radio shutdown, the power of the transmitter is set to the reduced level via the low splatter ramp controller circuit 48.

Under the control of the current detector circuit 12, an output 52 from the low splatter ramp controller circuit 48 and/or an output 54 from the level training circuit 30 are respectively forwarded to a low splatter ramp multiplier 56 and a level training multiplier 58, which scale a complex baseband I/Q signal 60 into a signal that feeds the summation circuit 42. Specifically, an output 62 based on the baseband I/Q signal 60 and the output 52 from the low splatter ramp controller circuit 48 is generated from the low splatter ramp multiplier 56, which is forwarded to the level training multiplier 58. Using the output 62 and the output 54, the level training multiplier 58 generates a complex output 64 to the summation circuit 42. A feedback amplifier 66 returns another feedback output 67 to the summation circuit 42, which adds the feedback output 67 and output 64 to generate the sum voltage 40. The summation circuit 42, in turn, forwards the sum voltage 40 to the clip detector 38 for comparison with the clip threshold 44 and a loop filter and amplifier 68 that generates an output signal 70 based on a transfer function (“F(s)”) using the voltage sum signal 40. The loop filter and amplifier 68 sets the stability of the Cartesian Feedback loop.

The output signal 70 from the loop filter and amplifier 68 is forwarded to a quadrature up mixer 72, which mixes the output signal 70 with a Local Oscillator (“LO”) injection and delivers RF signal 76 to the input of the RFPA. The LO injection 74 is also applied to a phase shifter block 78, which delivers an RF shifted LO injection to quadrature RF down mixer 80. The phase shifter 78 provides the adequate phase difference between up-mixing and down-mixing functions to maintain adequate Cartesian Feedback loop stable operation. As typically done in a Cartesian feedback transmitter, the down mixer 80 downconverts to baseband a sample of the RFPA output 82. The downconverted signal 84 is fed to the summation circuit.

The Cartesian feedback loop described is commonly known in the art. Unlike the prior art, however, the resultant transmitter current of the RFPA in the feedback loop shown in this embodiment is also controlled by the training current threshold 24 and the transmission current threshold 26 via the current detector circuit 12. As a result, the transmitter current can be properly assessed and the circuits that are over-utilizing the power of the transmitter can be shutdown or reduced before an early radio shutdown occurs. It should be noted that this embodiment shown in FIG. 1 is one of many ways to implement the circuitry of the transmitter, and as such, other alternative embodiments that are readily appreciated by a skilled artisan are within the various teachings of the invention.

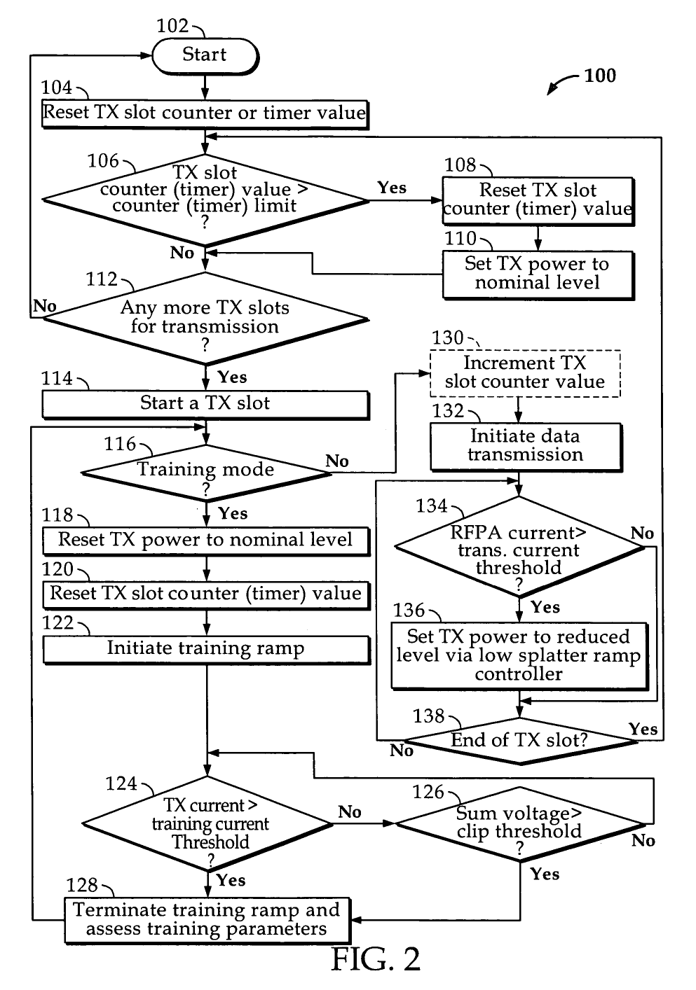

Turning now to FIG. 2, a flow chart diagram illustrating the process 100 of the transmitter according to various embodiments of the invention is shown and indicated generally at 100. The process 100 corresponds to the embodiment shown in FIG. 1. As described previously, since the circuitry of the transmitter can be altered, other processes to implement the different circuitry of the transmitter are readily appreciated by one skilled in the art. Thus, other processes and/or slight alternation of the process 100 are contemplated, and they are within the teachings of the various embodiments in the invention.

The process 100 starts 102 with an initiation of resetting 104 a transmitter slot counter value or a transmitter timer value. As commonly known in the art, the transmitter slots can be tracked either by a counter or a timer. Thus, both implementations of using a counter and/or timer are contemplated and are within the scope of the various teachings described. Once the transmitter slot counter value or transmitter timer value has been reset 104, the process next determines 106 whether the transmitter slot counter value or the transmitter timer value corresponds at least in a predetermined way to a predefined counter or timer limit, respectively. Specifically, it is determined whether the transmitter slot counter value or the transmitter timer value is greater than the counter limit or the timer limit. If so, the transmitter slot counter value or transmitter timer value would be reset 108 to its initial value, which is generally a zero value. The power of the transmitter is also reset 110 to the nominal level to initialize the process. At this time, it is next checked to determine 112 whether there are any more transmitter slots that need to be transmitted. If so, the process loops back to the start 102 of the process 100. Since this is the first iteration, there is likely a transmitter slot waiting for transmission, and the transmitter slot is accordingly started 114 to initiate the transmission process.

In response to starting this transmitter slot, the process determines 116 whether the transmitter slot is in a level training mode. If so, the transmitter power is reset 118 to the nominal level and the transmitter slot counter or timer value is reset to its initial value before the level training mode is initiated. Specifically, once the transmitter power and the transmitter slot counter or timer value has been reset, the training ramp is initiated 122 to enable the level training mode. With the training ramp, the process continuously checks the transmitter current from the RFPA against the training current threshold. Specifically, an output of the transmitter current from the RFPA is checked to determine 124 whether it corresponds in at least a predetermined way to the training current threshold. In this embodiment, it is determined 124 whether the transmitter current is greater than the training current threshold. If not, the process next determines 126 whether the sum voltage from the summation circuit is greater than the clip threshold. In this embodiment shown, if either the transmitter current or the sum voltage is greater than the training current threshold or the clip threshold, respectively, the training ramp that was initiated will be terminated 128 to avoid high peak current during high VSWR conditions that may result in an early shutdown of the transmitter.

The process then loops back to determine whether the transmitter slot is currently in the level training mode. In this case, since the training ramp has been terminated 128, the transmitter slot is no longer in level training mode. At this point, the process would increment 130 the transmitter slot counter value if the counter implementation is used. If, on the other hand, the timer implementation is used, there is no need to increment the timer value, because the transmitter timer value is tracked using a time clock. The transmitter slot is switched from the level training mode to data transmission mode. As such, data transmission is initiated 132 for the transmitter slot, and the transmitter current from the RFPA is compared to the transmission current threshold to track excessive current usage from the data transmission, which can cause high peak current in high VSWR conditions. Specifically, in this embodiment, the process determines 134 whether the transmitter current is greater than the transmission current threshold. If so, the power of the transmitter is set 136 to the reduced level via the low splatter ramp controller. As a result, excessive current usage that can cause the early radio shutdown can be avoided. If, on the other hand, the transmitter current is not greater than the transmission current threshold, the power of the transmitter is not adjusted. The process next determines 138 whether the transmitter slot has come to an end, and if not, the process loops back to keep checking 134 the transmitter current against the transmission current threshold. If, however, the transmitter slot is at the end, the process loops back to the beginning to check 106 the transmitter slot counter or timer value against the counter or timer limit. The process is reiterated from this point for another slot transmitter available for transmission.

With these various teachings shown, a novel power management of the transmitter of a mobile station has been provided. Specifically, by checking the transmitter current of the RFPA against two separate thresholds of the level training mode and the data transmission mode, excessive current usage under VSWR conditions is minimized to avoid high peak current that causes unnecessary premature shutdown of the transmitter. The training ramp of the level training mode can now be properly monitored and terminated as needed. Similarly, excessive current usage during data transmission can also be monitored and reduced to avoid the high peak current under VSWR conditions. Moreover, the present power management can be implemented with the existing clip detection circuit that also monitors and terminates the training ramp based on a comparison to the clip threshold. As a result of the various teachings provided, the transmitter can avoid the high peak current during VSWR conditions that can cause an unwanted early shutdown of the transmitter.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of managing power of a transmitter on a mobile station comprising:
starting a transmitter slot;
determining whether the transmitter slot is in a level training mode;
initiating a training ramp when the transmitter slot is in the level training mode;
determining whether a transmitter current corresponds in at least a predetermined way to a training current threshold;
terminating the training ramp when the transmitter current corresponds in at least the predetermined way to the training current threshold.

2. The method according to claim 1, wherein the training current threshold comprises any one or more selected from a group of a predefined value and a dynamically assigned value.

3. The method according to claim 1, wherein the transmitter current comprises any one or more selected from a group of a radio frequency amplifier current, a mobile station current, and a total mobile station current.

4. The method according to claim 1 further comprising:
determining whether a sum voltage corresponds in at least a predetermined way to a clip threshold;
terminating the training ramp when the sum voltage corresponds in at least the predetermined way to the clip threshold.

5. The method according to claim 1 further comprising, wherein prior to initiating the training ramp:
resetting a power of the transmitter to a nominal level;
resetting a slot counter value of the transmitter.

6. The method according to claim 1 further comprising, wherein prior to initiating the training ramp:
resetting a power of the transmitter to a nominal level;
resetting a transmitter timer value of the transmitter.

7. The method according to claim 1 further comprising:
initiating a data transmission when the transmitter slot is not in the level training mode;
determining whether the transmitter current corresponds in at least a predetermined way to a transmission current threshold;
setting a power of the transmitter to a reduced level when the transmitter current corresponds in at least the predetermined way to the transmission current threshold.

8. The method according to claim 7 further comprising:
incrementing a transmitter slot counter to provide an incremented transmitter slot counter value;
determining whether the incremented transmitter slot counter value corresponds in at least a predetermined way to a predefined counter limit value;
resetting the transmitter slot counter when the incremented transmitter slot counter value corresponds in at least the predetermined way to the predefined counter limit value;
setting the power of the transmitter to a nominal level.

9. The method according to claim 7 further comprising:
determining whether a transmitter timer value corresponds in at least a predetermined way to a predefined timer limit value;
resetting the transmitter timer value when the transmitter timer value corresponds in at least the predetermined way to the predefined timer limit value;
setting the power of the transmitter to a nominal level.

10. The method according to claim 7 further comprising:
determining whether the transm9itter slot is at an end;
repeating the determining whether the transmitter current corresponds in at least the predetermined way to the transmission current threshold when the transmitter slot is not at the end;
determining whether there is a next transmitter slot available for transmission when the transmitter slot is at the end;
repeating the method for the next transmitter slot when there is a next transmitter slot.

11. A method of managing power of a transmitter on a mobile station comprising:
starting a transmitter slot;
determining whether the transmitter slot is in a level training mode;
initiating a data transmission when the transmitter slot is not in the level training mode;
determining whether a transmitter current corresponds in at least a predetermined way to a transmission current threshold;
setting a power of the transmitter to a reduced level when the transmitter current corresponds in at least the predetermined way to the transmission current threshold.

12. The method according to claim 11, wherein the power of the transmitter is set to the reduced level by a low splatter ramp controller.

13. The method according to claim 11, wherein the transmission current threshold comprises any one or more selected from a group of a predefined value and a dynamically assigned value.

14. The method according to claim 11 further comprising:
incrementing a transmitter slot counter to provide an incremented transmitter slot counter value;
determining whether the incremented transmitter slot counter value corresponds in at least a predetermined way to a predefined counter limit value;
resetting the transmitter slot counter when the incremented transmitter slot counter value corresponds in at least the predetermined way to the predefined counter limit value;
setting the power of the transmitter to a nominal level.

15. The method according to claim 11 further comprising:
determining whether a transmitter timer value corresponds in at least a predetermined way to a predefined timer limit value;
resetting the transmitter timer value when the transmitter timer value corresponds in at least the predetermined way to the predefined timer limit value;
setting the power of the transmitter to a nominal level.

16. The method according to claim 11 further comprising:
determining whether the transmitter slot is at an end;
repeating the determining whether the transmitter current corresponds in at least the predetermined way to the current threshold when the transmitter slot is not at the end;
determining whether there is a next transmitter slot available for transmission when the transmitter slot is at the end;
repeating the method for the next transmitter slot when there is a next transmitter slot.

17. An apparatus for managing power of a transmitter on a mobile station comprising:
a power source of the mobile station that provides a transmitter current;
a current detector circuit operably coupled to the power source, wherein the current detector circuit decides to set a power of the transmitter to a reduced level responsive to the transmitter current corresponding in at least a predetermined way to a transmission current threshold.

18. The apparatus as defined in claim 17 further comprising:
a low splatter ramp controller circuit operably coupled to the current detector circuit, wherein the low splatter ramp controller circuit sets a power of the transmitter to the reduced level.

19. The apparatus as defined in claim 17, wherein the current detector circuit further decides to terminate a training ramp responsive to the transmitter current corresponding in at least the predetermined way to a training current threshold.

20. The apparatus as defined in claim 17 further comprising:
a clip detector circuit that decides to terminate the training ramp responsive to a sum voltage corresponding in at least a predetermined way to a clip threshold;
a level training circuit operably coupled to the current detector circuit and the clip detector circuit, wherein the level training circuit terminates the training ramp.
